(19) United States
(12) Patent Application Publication
(10) Pub. No.: US 2023/0211656 A1
(43) Pub. Date: Jul. 6, 2023

(54) CO2 Electrochemical reduction based solar powered hybrid internal combustion engine and battery electric vehicle

(71) Applicant: Yonghua Wang, Klamath Falls, OR (US)

(72) Inventor: Yonghua Wang, Klamath Falls, OR (US)

(21) Appl. No.: 17/300,966

(22) Filed: Dec. 31, 2021

(51) Int. Cl. B60K 6/28; B60K 6/24; F02M 21/02

(52) U.S. Cl. CPC B60K 6/28; B60K 6/24; F02M 21/0206; F02M 21/0221; B60K 2016/003

(57) ABSTRACT

A CO2 electrochemical reduction based solar powered hybrid internal combustion engine and battery electric vehicle system employs CO2 to drive hybrid electric vehicles. The inflatable non-imaging solar concentrator based concentrating hybrid solar thermal and photovoltaic system with ultra-high efficiency, extremely low cost, and super-light weight is able to electrochemically reduce the CO2 into CO and supply fuel to CO internal combustion engine. The thermoelectric activated thermal electricity storage is integrated into the system to store thermal energy and regenerate electric power. The entire system is made into a mobile EV charging station. The mobile EV charging station is not only able to generate electric power locally to charge EVs, but also able to transport power from solar powered EV changing station network and power grid to the sites where EVs are located.

### TECHNICAL FIELD

The present disclosure relates generally to solar powered Electric Vehicle (EV), more specifically, to solar powered CO2 electrochemical reduction based hybrid internal combustion engine and battery electric vehicle.

### BACKGROUND

Carbon based fossil fuels are approved to be the best mediums of solar energy storage, however it takes millions of years to turn the solar energy accumulated into plants and animals into fossil fuels and the modern usage of fossil fuel emits carbon dioxide. Therefore, the modern society is facing to the grant challenges of fossil fuel depletion and global warming. In order to address the energy crisis and curb the climate change, the entire world is accelerating in transition toward the renewable energy dominated society. Contrast to fossil fuels, most renewable energies such as solar energy have the drawbacks of low energy current density and intermittence. The downsides of renewable energies result in the high cost, low efficiency, and intermittence of renewable energy technologies. In order to promote the wide-spread adoption of renewable energy and eventually substitute fossil fuels with renewable energies, the cost of renewable energy technologies must be dramatically reduced; the efficiency of the renewable technologies must be substantially raised; and cost effective energy storage technologies must be created.

As one of the three major sectors of energy consumption, the world auto-industry is undergoing the transformative transition from internal combustion engine vehicles to EVs. However, the wide-spread adoption of EVs is hammered by prolonged charging time and high cost of EVs. One of solutions in addressing the fundamental issues of EVs is Hybrid Electric Vehicle (HEV). HEV is the combination of fuel internal combustion engine vehicle and battery driven motor vehicle. HEV including its modification Plug-in Hybrid Electric Vehicle (PHEV) employs conventional fuel internal combustion engine which consumes gasoline or diesel to extend the range and reduce the size of the battery bank of the battery driven motor vehicle. HEV is widely accepted due to its releasing of range anxiety and obtained deep market penetration under the current EV charging infrastructure situation. However, the HEV bonded to fossil fuel after all is a temporary solution; the fossil fuel is eventually gone.

Severinsky U.S. Pat. Nos. 5,343,970 and 6,209,672 B1 disclosed hybrid electric vehicles aiming at improving fuel efficiency and reducing pollutant emission. This type of hybrid electric vehicle still consumes fossil fuel and emits green house effect gas. Although, in some extent, it contributes to curbing climate change, it does not reverse the trend of global warming, as the present invention.

If the fossil fuel is completely removed from the hybrid electric vehicle system and replaced with other alternative fuels or even the green house effect gas such as CO2, as the present invention, it is necessary to build up the gas filling infrastructure as the gas station network. Corresponding to the transition of fossil fuel to CO2 gas, the design paradigm of the hybrid electric vehicle need to be varied to facilitate the development of gas transportation and distribution system, as the present invention.

Contrast to internal combustion engine vehicle which is based on fossil fuel with energy density 100-200 times higher than that of battery storage, EVs based on battery storage need energy replenishments frequently. Therefore EVs need the distributed charging stations, especially along highways and in remote areas, to replenish energy anywhere in time. The distribution nature of solar energy source provides the possibility to generate power anywhere locally to charge EVs in time. The power supply from solar power generation stations perfectly matches the power demand from EVs. However, due to the low energy current density of solar irradiance, solar powered EV charging stations need large areas of land to collect sufficient sunlight and generate enough power to charge EVs. Obviously, qualified solar fields for EV charging stations are not always available at where the EV charging stations are needed. Hence, mobile EV charging stations which can transfer power from fixed charging stations to EVs located in different places would be the “holy grail” to promote the wide-spread adoption of EVs. In particular, if the mobile EV charging stations are solar powered, they might be the dynamic extension of the fixed solar powered EV charging station network and serve as the interconnects between the fixed EV charging stations. Furthermore, these mobile charging stations may serve as connection between the fixed EV charging station network and the normal power grid system.

Mobile EV charging stations may function as the power transportation vehicles to transport the battery charged by fixed solar power generation stations to the sites where the EVs are located, or the solar power generation stations themselves towered or driven to the sites where they collect sunlight and generate power to charge EVs locally. US patent 2015/0288317 A1 applied by Huang et al (Huang) disclosed a solar power mobile charging station which includes a foldable solar panel and a battery configured to receive electricity generated from the solar panel and charge one or two electric vehicles. In Huang's disclosure, the solar power charging system is towered or driven to where the EVs are located, the system itself has no driving system. Huang's system is based on flat plate photovoltaic panel which has limited conversion efficiency, significant cost, and non-negligible self weight. In Huang's system, the electric power is generated locally with a foldable solar panel to charge EVs. But, the system is neither able to transport the power generated in fixed solar power generation stations located in other areas to charge EVs, nor able to transport electric power from power grid to the EV charging sites. Furthermore, Huang's system is limited by the low conversion efficiency and heavy weight of the conventional solar panels. In Huang's system, only battery is deployed to store the solar panel generated electric power, no mechanism is deployed to store the solar panel generated thermal energy and enhance electric power generation and storage.

U.S. Pat. No. 8,963,481 B2 granted to Prosser et al (Prosser) disclosed a charging service vehicle which transports battery modules to provide roadside assistance or rescue. Prosser's invention is able to transport the power generated by the solar power generation stations in other areas to the EV charging sites for charging EVs, but Prosser's vehicles can't generate power locally at the EV charging sites by using solar power.

While the combination of the prior arts can create a mobile solar power system to transport electric power and charge EVs located at different sites, it is unable to incorporate the Concentrating Photovoltaic (CPV), which has potential to significantly increase the conversion efficiency, dramatically reduce the cost, and fundamentally decrease the weight of the solar power system, into the mobile solar power system, as the present invention.

In order for the mobile solar power system to be able to charge EVs and to be charged by the fixed solar power generation stations in other areas or power grid, the mobile solar power system is equipped with an on board bi-directional charger.

The characteristics of the present invention will become more apparent as the present description proceeds.

### OBJECTS

The objects of this invention are to: (1) remove the fossil fuel completely from the hybrid electric vehicle system and replace it with green house effect gas CO2; (2) incorporate the onboard electrochemical CO2 reduction system to convert CO2 into CO as fuel to supply to the internal combustion engine; (3) add CO storage system to store energy; (4) add swappable CO2 tanks to facilitate the development of the gas transportation and distribution system; (5) create a mobile solar power system with ultra-high efficiency, substantially low cost, and super-light weight for charging EVs; (6) enable Concentrating Photovoltaic (CPV) system based mobile solar power EV changing system through adoption of the inflatable non-imaging solar concentrators; (7) make the mobile solar power system a self-drivable transportation tool to transport power between the fixed solar power stations in other areas and the EV charging sites; (8) add thermoelectric active thermal storage, addition to battery storage system, to the storage system of the mobile solar power system to store thermal energy and ultimately turn the stored thermal energy back to electric power; (9) enable the bi-directional charging of the mobile solar power system.

### SUMMARY

Instead of using other alternative green fuels such as ethanol, bio-diesel, or hydrogen to replace the fossil fuels used in hybrid electric vehicle, the present invention adopts the green house effect gas CO2 to replace the fossil fuel in conventional hybrid electric vehicle for energy supply to the internal combustion engine. The CO2 filled in a swappable fuel tank of the hybrid electric vehicle system of the present invention is electrochemically reduced into CO by using the electric power generated by the onboard Concentrating Photo Voltaic (CPV) system through the onboard electrolysis system. The CO is then compressed into a high pressure tank as fuel to supply energy to the internal combustion engine of the hybrid electric vehicle of the present invention. The swappable fuel tanks for CO2 will be used to transport and distribute CO2 and shared with the hybrid electric vehicles of the present invention to replenish fuel. The hybrid electric vehicle of the present invention will be equipped with bio-directional charger to make it into a mobile EV charging station to charge other EVs or other power grids.

According to the present invention, CO2 electrochemical reduction based solar powered hybrid internal combustion engine and battery electric vehicle comprises: an inflatable solar concentrator based concentrating hybrid solar thermal and photovoltaic system array with active thermal storage and thermoelectric power generation systems; a CO2 electrolysis system; a swappable CO2 tank; a CO compressing system; a swappable CO storage tank; a CO internal combustion engine; an electric motor/generator; a battery storage system; a bi-directional charger; a control system; a mobile platform.

In the system of the present invention, the components are configured in such a way that the inflatable solar concentrator combines with a photovoltaic receiver integrated with a thermoelectric active thermal storage package to form an inflatable hybrid solar thermal and photovoltaic unit with thermal energy storage; the concentrating hybrid units are connected to form an array; the array is installed on the mobile platform to generate power to power the onboard CO2 electrolysis system to generate CO; the CO compressing system compresses the CO into the CO storage tank; the CO storage tank is connected to the internal combustion engine to supply fuel; the internal combustion engine is connected to the electric motor/generator in “series” or “parallel” to generate torque; a battery storage system is incorporated into the mobile system to power the electric motor; a bi-directional charging system is incorporated into the mobile system to charge EVs or to be charged by solar power generation systems in other areas or power grid; a control system is incorporated into the mobile system to coordinate all the components; a self-driving system including the electric motors, power train, and electric control system is incorporated into the mobile system. When in operation, the inflatable solar concentrator concentrates both of the incident beam sunlight and diffuse sunlight to the receiver, where portion of the light is directly converted into electricity by the photovoltaic cells integrated into the hybrid solar thermal and photovoltaic receiver and the rest is converted into heat which is then extracted, raised in temperature, and stored into the thermal storage package by the thermoelectric modules integrated into the hybrid solar thermal and photovoltaic receiver; the stored thermal energy will flow through the thermoelectric modules and be turned back to electric power; the photovoltaic generated electric power is directly conducted to the onboard electrolysis system to reduce CO2 into CO and supply to the internal combustion engine to drive the mobile system; the bi-directional charger is deployed to charge EVs or get the battery system charged by the solar power system located in other areas or power grid system. Therefore, the mobile system of the present invention can either transport the power generated by the solar power systems located in other areas to the EV charging sites or generate power locally at the charging sites to charge EVs. Due to the ultra-high efficiency, substantially low cost, and super-light weight of the inflatable solar concentrator based hybrid concentrating solar thermal and photovoltaic system unit, the entire mobile system realizes ultra-high efficiency, substantially low cost, and super-light weight. Apart from the CO storage, the integrated thermoelectric active thermal storage is able to store the cogenerated heat from the concentrating hybrid solar thermal and photovoltaic system, and turn it back to electric power when it is needed. The solar powered mobile system is not only able to transport power from other solar power generation stations and power grid to charging sites to charge EVs, but also able to generate power locally to charge EVs. Therefore, it has potential to turn parking lots into power generation stations.

Instead of emitting green house effect gas, the present invention takes the green house effect gas CO2 as fuel to drive hybrid electric vehicle. It is not only able to eliminate the CO2 emission, but also able to reduce the CO2 emitted into the atmosphere. Furthermore, the CO2 can be recycled again and again. Contrast to hydrogen, CO2 is safe and easy to store, transport, and distribute. The CO2 swappable tank design in the hybrid electric vehicle of the present invention will greatly facilitate the CO2 transportation and distribution infrastructure construction. The hybrid electric vehicle of the present invention not only inherits the advantage in extending the range and reducing the size of the battery bank from the conventional hybrid electric vehicle, but also enables it to take advantage of using both EV charging station infrastructure and the upcoming CO2 filling infrastructure. As the mobile EV charging stations, the hybrid electric vehicles of the present invention will dramatically promote the wide-spread adoption of conventional electric vehicles.

Further aspects and advantages of the present invention will become apparent upon consideration of the following description thereof, reference being made of the following drawing.

### BRIEF DESCRIPTION OF THE DRAWINGS

The accompanying drawings, which are incorporated in and constitute a part of this specification, illustrate an embodiment of the invention and together with the description, serve to explain the principles of the invention.

FIG. 1 is the schematic indication of the CO2 electrochemical reduction based solar powered hybrid internal combustion engine and battery electric vehicle system.

FIG. 2 is the schematic indication of the system configuration of the CO2 electrochemical reduction based solar powered hybrid internal combustion engine and battery electric vehicle system.

FIG. 3 is the schematic indication of the system configuration of the CO2 electrochemical reduction based solar powered hybrid internal combustion engine and battery electric vehicle system with highlight of the swappable CO2 tanks and CO storage tanks.

FIG. 4 is the inflatable non-imaging solar concentrator based concentrating hybrid solar thermal and photovoltaic system unit with a receiver integrated with a thermoelectric activated thermal electricity storage package.

FIG. 5 is the swappable CO2 and CO storage tanks with automatic controlled valves.

FIG. 6 is the configuration charter of the entire CO2 electrochemical reduction based solar powered hybrid internal combustion engine and battery electric vehicle system.

FIG. 7 is the hybrid solar thermal and photovoltaic receiver with thermoelectric activated thermal storage package.

FIG. 8 is the cross section view of the hybrid solar thermal and photovoltaic receiver with thermoelectric activated thermal storage package

FIG. 9 is the hybrid solar thermal and photovoltaic receiver component with thermoelectric modules.

FIG. 10 is the thermal storage component of the thermoelectric activated thermal storage package.

FIG. 11 is the schematic structure of the hybrid solar thermal and photovoltaic receiver with thermoelectric activated thermal storage package and its energy storage work principle explanation.

### DETAILED DESCRIPTION

Reference will now be made in detail to the present exemplary embodiments, examples of which are illustrated in the accompanying drawings. Wherever possible, the same reference numbers will be used throughout the drawings to refer to the same or like parts.

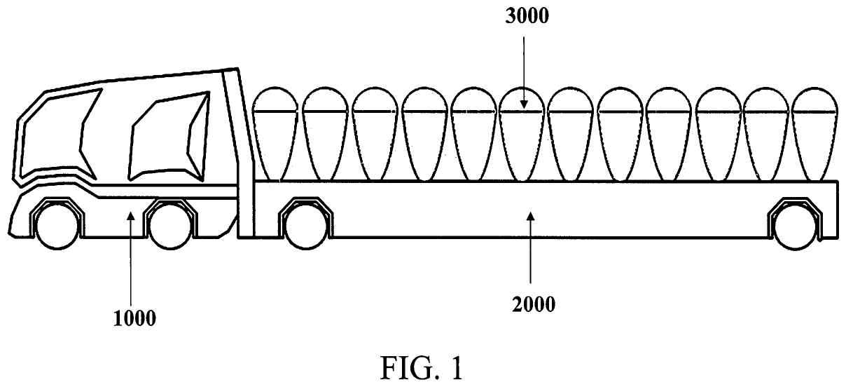

Referring to FIG. 1, the mobile inflatable hybrid concentrating solar thermal and photovoltaic system based electric vehicle charging station consists of the driving electric vehicle 1000, the mobile platform 2000, the inflatable non-imaging solar concentrator based hybrid concentrating solar thermal and photovoltaic system unit array 3000, and the bidirectional charger 4000 which is embedded into the mobile platform 2000 and is not indicated in FIG. 1.

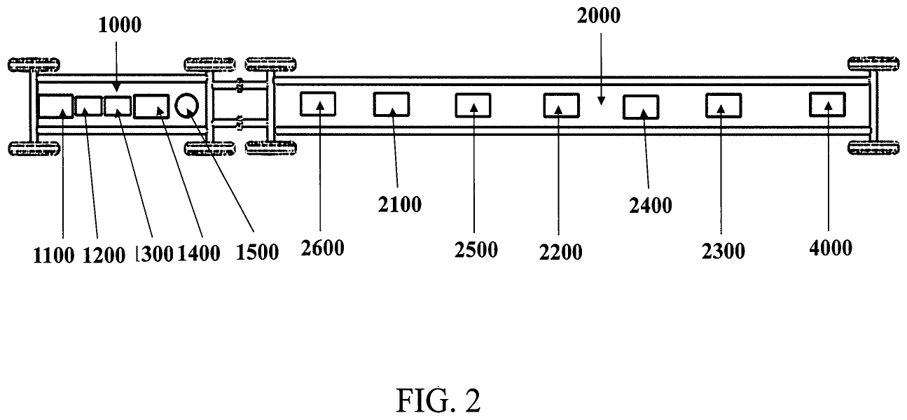

Referring to FIG. 2, the power train of the driving electric vehicle 1000 includes the battery pack 1100, the converter 1200, the inverter 1300, the Electronic Control Unit (ECU) and battery management 1400, and the electric motor 1500. The power system of the mobile charging station consists of the battery bank 2100, the control system 2200, the hybrid solar thermal and photovoltaic receiver with thermoelectric activated thermal storage 2300, CO2 electrolysis system 2400, CO compressor system 2500, CO internal combustion engine 2600, and the bidirectional charger 4000.

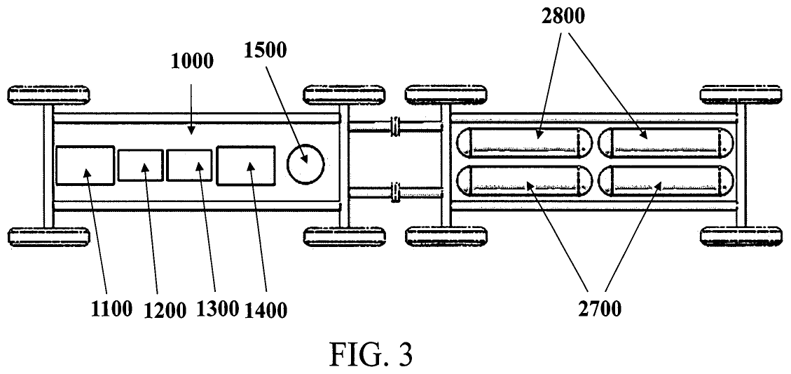

Referring to FIG. 3, the power system of the mobile charging station consists especially the swappable CO storage tank system 2700 and swappable CO2 storage tank system 2800.

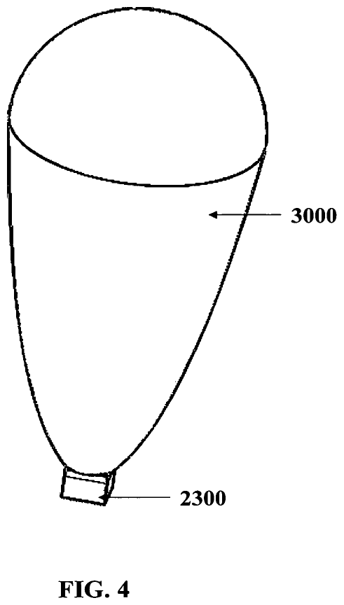

Referring to FIG. 4, the inflatable solar concentrator 3000 based concentrating hybrid solar thermal and photovoltaic system consists a receiver 2300 with thermoelectric activated thermal electricity storage.

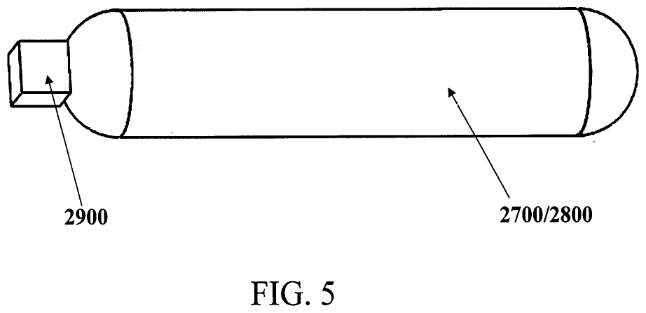

Referring to FIG. 5, the swappable CO2 and CO storage tanks 2700/2800 have automatically controlled valves 2900.

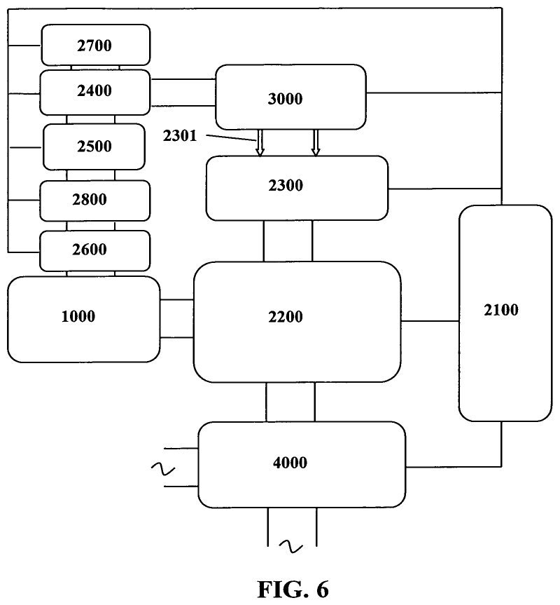

Referring to FIG. 6, the power system of the entire CO2 electrochemical reduction based solar powered hybrid internal combustion engine and battery electric vehicle consists of the driving electric vehicle 1000, the battery bank 2200, hybrid solar thermal and photovoltaic receiver with thermoelectric activated thermal storage package array 2300, control system 2100, CO2 electrolysis system 2400, swappable CO2 storage tank system 2800, CO compressor system 2500, swappable CO storage tank system 2700, CO internal combustion engine system 2600, which are embedded into the mobile platform, the inflatable non-imaging solar concentrator based hybrid concentrating solar thermal and photovoltaic system unit array 3000, and the bidirectional charger 4000. When in operation, the inflatable non-imaging solar concentrator array of the inflatable non-imaging solar concentrator based hybrid concentrating solar thermal and photovoltaic system unit array concentrates sunlight and couples concentrated sunlight 2301 onto the hybrid solar thermal and photovoltaic receiver with thermoelectric activated thermal storage package 2300, portion of it is converted into electricity which is conducted to the CO2 electrolysis system 2400 to electrochemically reduce it into CO, the CO is compressed by the compressor system 2500 into the swappable CO storage tank system 2700 to supply to the CO internal combustion engine 2600, which is coupled with the driving system 1000 to generate torque or generate power, the rest is converted into thermal energy and raised in temperature and stored into the thermal storage. When needed, the stored thermal storage is extracted to regenerate power through the thermoelectric modules in the package. The stored power in the battery bank 2200, and the stored thermal energy in 2300 can be extracted to charge electric vehicles through the bi-directional charger 4000. The battery bank can be also charged by other solar power generation systems or power grid through the bidirectional charger 4000.

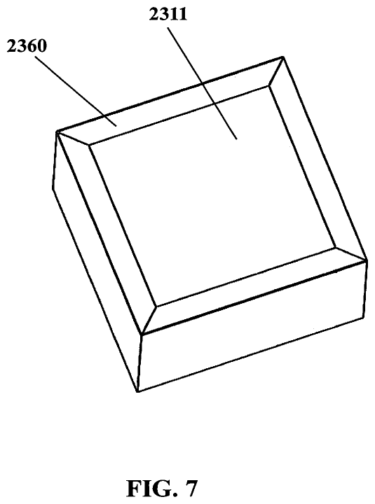

Referring to FIG. 7, the hybrid solar thermal and photovoltaic receiver with thermoelectric activated thermal storage is an insulated power generation and energy storage package.

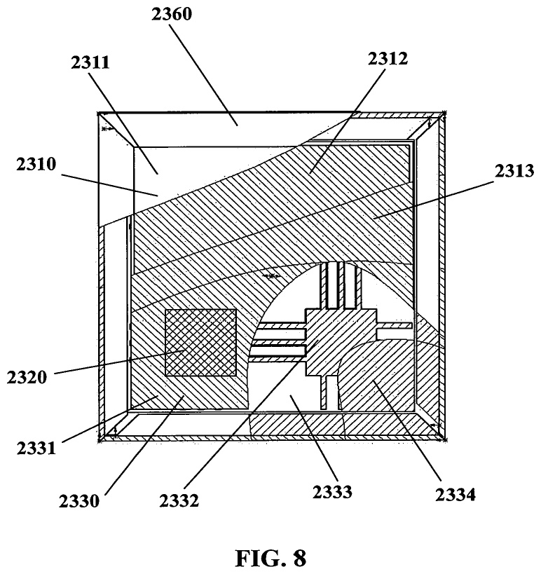

Referring to FIG. 8, the hybrid solar thermal and photovoltaic receiver with thermoelectric activated thermal storage consists of hybrid photovoltaic and thermal panel 2310 which comprises the glazing 2311, solar cell array 2312, and the metal sheet 2313, thermoelectric module 2320, thermal storage package 2330 which comprises the top insulation layer 2331, heat exchanger 2332, thermal mass 2333, and backside insulation layer 2334, and frames 2360 with side insulation materials. The hybrid photovoltaic and thermal panel 2310 is laminated and sealed; the thermoelectric modules 2320 are attached to the backside of the metal sheet 2313; the heat exchanger 2332 is attached to the thermoelectric modules surrounded by the insulation layer 2331; the heat exchanger 2332 is buried into the thermal mass which is insulated by the back side insulation layer 2334 and the side insulation materials within frames 2360. When in operation, the incident sunlight penetrates through the glazing 2311 and reaches the solar cell arrays 2312; a portion of the sunlight is converted into electricity directly, and rest become heat; the heat is extracted, boosted its temperature, and transferred to the heat exchanger 2332 by the thermoelectric modules 2320; the heat exchanger 2332 distributes the heat into the thermal mass 2333. When at night or in cloudy days, the stored heat in the thermal mass 2333 transferring through the heat exchanger 2332 and the thermoelectric modules 2320, is converted back into electricity by the thermoelectric modules 2320 which is operating in the generator mode at this movement.

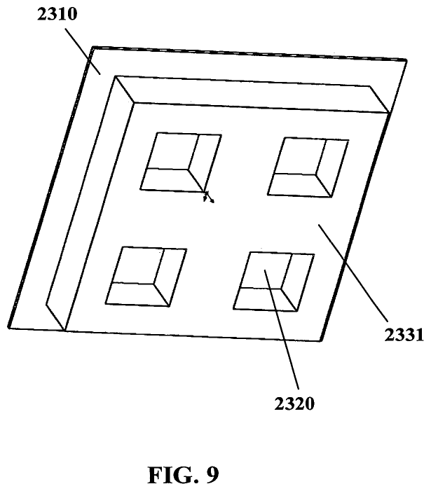

Referring to FIG. 9, the assembly of the hybrid photovoltaic and thermal panel 2310, thermoelectric modules 2320, and insulation layer 2331, is further illustrated.

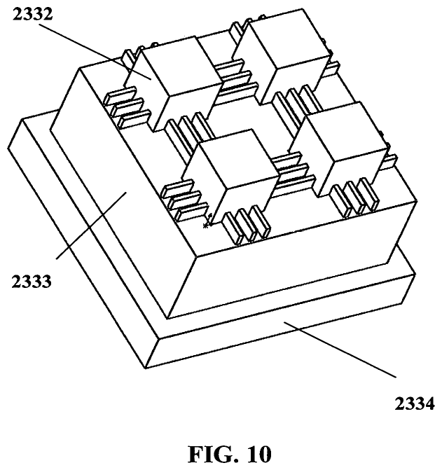

Referring to FIG. 10, the assembly of the heat exchanger 2332, thermal mass 2333 and the backside insulation layer 2334 is further illustrated.

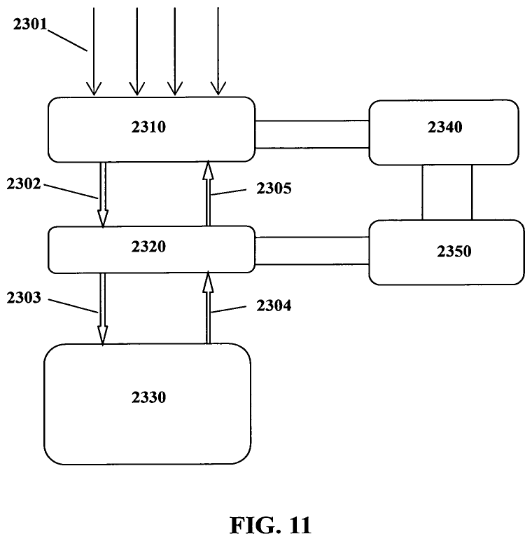

Referring to FIG. 11, the entire hybrid photovoltaic and thermal panel, thermoelectric module, and thermal storage module system comprises the hybrid photovoltaic and thermal panel 2310, thermoelectric modules 2320, thermal storage package 2330, battery bank 2340 and control system 2350. When in operation, the sunlight 2301 shines on the hybrid photovoltaic and thermal panel 2310, which cogenerates electricity and heat, the cogenerated electricity is conducted to the battery bank 2340, and the cogenerated heat 2302 is transferred to thermoelectric modules and boosted up to higher temperature heat 2303, then transferred into the thermal storage package 2330. At night or in cloudy days, the stored heat 2304 flow through the thermoelectric modules 2320 to convert it back to electricity with control system 2350 to switch the operating modes of the thermoelectric modules from cooler to generator, the heat 2305 dissipated from the thermoelectric modules 2320 is transferred back to the hybrid photovoltaic and thermal panel 2310. The thermoelectric module generated electricity is conducted to battery bank 2340 through the control system 2350.

From the description above, number of advantages of the CO2 electrochemical reduction based solar powered hybrid internal combustion engine and battery electric vehicle system become evident. Instead of emitting CO2 as the conventional hybrid electric vehicle, the CO2 electrochemical reduction based solar powered hybrid internal combustion engine and battery electric vehicle consume CO2 and solar energy simultaneously. CO is employed to store solar energy and drive electric vehicle through the internal combustion engine. The CO2 electrochemical reduction based solar powered hybrid internal combustion engine and battery electric vehicle can be electrically charged anywhere and anytime when the charging stations and time are available. The hybrid concentrating solar thermal and photovoltaic system with ultra-high efficiency, extremely low cost and super light weight is used in mobile EV charging stations. The thermoelectric activated thermal storage system, which not only facilitates the energy storage, but also enhances photovoltaic power generation through cooling the photovoltaic panel, is integrated into the mobile charging station. The bidirectional charger, which can be used to charge EVs and get the mobile charging station charged by other solar generation systems and power grid to transport power from one place to another, is incorporated into the system. As a mobile system, this invention extends the solar powered EV charging station network and connect it to conventional power grid.

In the preceding specification, various preferred embodiments have been described with reference to the accompanying drawings. It will, however, be evident that various other modifications and changes may be made thereto, and additional embodiments may be implemented, without departing from the broader scope of the invention as set forth in the claims that follow. The specification and drawings are accordingly to be regarded in an illustrative rather than restrictive sense.

Other embodiments of the invention will be apparent to those skilled in the art from consideration of the specification and practice of the invention disclosed herein. It is intended that the specification and examples be considered as exemplary only, with the true scope and spirit of the invention being indicated by the following claims.

I claim:

1. The CO2 electrochemical reduction based solar powered hybrid internal combustion engine and battery electric vehicle system comprises of: (a) an inflatable non-imaging solar concentrator array; (b) an electric driving system; (c) a mobile platform containing a battery bank, a hybrid solar thermal and photovoltaic receiver with thermoelectric activated storage package array, a CO2 electrolysis system, a CO compressor system, a swappable CO2 tank system, a swappable CO tank system, and an CO internal combustion engine; (d) a bidirectional charger; (e) a control system;
Wherein, the inflatable non-imaging solar concentrator array is optically coupled to the hybrid solar thermal and photovoltaic receiver with thermoelectric activated storage package array of the mobile platform; the hybrid solar thermal and photovoltaic receiver with thermoelectric activated storage package array is connected to the CO2 electrolysis system with electric cables; the CO2 electrolysis system is connected to the CO compressor system; the CO compressor system is connected to the swappable CO tank system; the swappable CO tank system is connected to the CO internal combustion engine; the CO internal combustion engine is connected with the electric driving system either in “series” or “parallel”; the bidirectional charger is connected with the battery bank with electric cables; and the control system is connected to the battery bank, hybrid solar thermal and photovoltaic receiver with thermoelectric activated storage package array, and the bidirectional charger with electric cables; the electric driving system is connected with the mobile platform, and the inflatable non-imaging solar concentrator array, the hybrid solar thermal and photovoltaic receiver with thermoelectric activated storage package array, the bidirectional charger, the battery bank, the CO2 electrolysis system, CO compressor system, CO internal combustion engine, swappable CO2 tanks, swappable CO tanks, the control system, are mounted on the mobile platform;
When in operation, the inflatable non-imaging solar concentrator based concentrating hybrid solar thermal and photovoltaic system with thermoelectric activated storage package array cogenerate electric power and thermal energy, the cogenerated electric power is used to electrochemically reduce the CO2 into CO, then CO is compressed into the swappable CO storage tanks by using the CO compressor system, and the cogenerated heat is stored in the thermal storage to be extracted out and turned back to electric power to charge the battery bank at night or in cloudy days; the battery bank is used to charge EVs through the bidirectional charger; in the case when the cogenerated power is not enough to charge multiple EVs, the battery bank of the charging station can be charged by other solar power generation stations or conventional power grid through the bidirectional charger, then transport power to the EVs located in other sites.

2. The CO2 electrochemical reduction based solar powered hybrid internal combustion engine and battery electric vehicle system of claim 1, wherein the electric driving system comprises a battery bank, a converter, an inverter, a motor, an Electronic Control Unit (ECU) and battery management system.

3. The CO2 electrochemical reduction based solar powered hybrid internal combustion engine and battery electric vehicle system of claim 1, the hybrid solar thermal and photovoltaic receiver with thermoelectric activated thermal storage package comprises a hybrid photovoltaic and thermal panel, which comprises a glazing, a solar cell array, and a metal sheet, thermoelectric modules, thermal storage package, which comprises a top insulation layer, a heat exchanger, thermal mass, and a backside insulation layer, and frames with side insulation materials.

4. The hybrid photovoltaic and thermal panel of claim 3, is laminated and sealed.

5. The thermoelectric modules of claim 3, are attached to the backside of the metal sheet and the heat exchanger is attached to the thermoelectric modules surrounded by the insulation layer.

6. The heat exchanger of claim 3, is buried into the thermal mass which is insulated by the back side insulation layer and the side insulation materials within frames.
When in operation, the incident sunlight penetrates through the glazing and reaches the solar cell arrays; a portion of the sunlight is converted into electricity directly, and rest become heat; the heat is extracted, boosted its temperature, and transferred to the heat exchanger by the thermoelectric modules; the heat exchanger distributes the heat into the thermal mass; When at night or in cloudy days, the stored heat in the thermal mass transferring through the heat exchanger and the thermoelectric modules, is converted back into electricity by the thermoelectric modules which is operating in the generator mode at this movement.
